(19) United States
(12) Patent Application Publication
(10) Pub. No.: US 2022/0156325 A1
(43) Pub. Date: May 19, 2022

(54) BINARY-ADDITION TREE ALGORITHM-BASED NETWORK ASSESSMENT METHOD AND SYSTEM THEREOF

(71) Applicant: NATIONAL TSING HUA UNIVERSITY, Hsinchu (TW)

(72) Inventor: Wei-Chang YEH, Hsinchu (TW)

(21) Appl. No.: 17/211,858

(22) Filed: Mar. 25, 2021

(30) Foreign Application Priority Data
Nov. 13, 2020 (TW) 109139805

(51) Int. Cl. G06F 16/901

(52) U.S. Cl. CPC G06F 16/9027

(57) ABSTRACT

A binary-addition tree algorithm-based network assessment method includes performing a parameter setting step, an arc enumerating step and an evaluating step. The parameter setting step is performed to set a plurality of state values of a state vector of one of a plurality of paths to 0, wherein the state vector of the one of the paths is represented by a binary value, and the state values of the state vector of the one of the paths are corresponding to a plurality of arcs, respectively. The arc path enumerating step is performed to enumerate all of the state values of the state vectors of the paths by adding 1 to the binary value corresponding to the state values of the state vector of the one of the paths according to a binary-addition tree algorithm. The evaluating step is performed to evaluate the state of the paths.

### RELATED APPLICATIONS

This application claims priority to Taiwan Application Serial Number 109139805, filed Nov. 13, 2020, which is herein incorporated by reference.

### BACKGROUND

### Technical Field

The present disclosure relates to a network assessment method and a system thereof. More particularly, the present disclosure relates to a binary-addition tree algorithm-based network assessment method and a system thereof.

### Description of Related Art

A plurality of nodes and a plurality of arcs connected to the nodes of the network can be an analyzing benchmark of a network model, no matter what the application system is, the actual operating state of the application system can be analyzed by the network model, and a best implementation strategy can be found by evaluating the reliability of the network. The system can make a decision by the best implementation strategy.

Although the technique of the conventional network model (such as Depth-First Search (DFS)) can evaluate the state of the network, the program is too complex, need a lot of storing space to store the state value, the efficiency may be decreased and cannot be processed parallelly. Thus, a binary-addition tree algorithm-based network assessment method and system simplifying program complexity, saving memory space, increase efficiency and parallel processing are commercially desirable.

### SUMMARY

According to one aspect of the present disclosure, a binary-addition tree algorithm-based network assessment method is configured to evaluate a state of a plurality of paths of a network, the paths include a plurality of nodes and a plurality of arcs connected to the nodes. The binary-addition tree algorithm-based network assessment method includes a parameter setting step, an arc-based path enumerating step and an evaluating step. The parameter setting step is performed to set a plurality of state values of a state vector of one of the paths to 0, wherein the state vector of the one of the paths is represented by a binary value, and the state values of the state vector of the one of the paths are corresponding to the arcs, respectively. The arc-based path enumerating step is performed to enumerate all of the state values of the state vectors of the paths by adding 1 to the binary value corresponding to the state values of the state vector of the one of the paths according to a binary-addition tree algorithm. The evaluating step is performed to evaluate the state of the paths of the network according to the state values of the state vectors of the paths.

According to another aspect of the present disclosure, a binary-addition tree algorithm-based network assessment method is configured to evaluate a state of a plurality of paths of a network, the paths include a plurality of nodes and a plurality of arcs connected to the nodes. The binary-addition tree algorithm-based network assessment method includes a parameter setting step, a node-based path enumerating step and an evaluating step. The parameter setting step is performed to set a plurality of state values of a state vector of one of the paths to 0, wherein the state vector of the one of the paths is represented by a binary value, and the state values of the state vector of the one of the paths are corresponding to the nodes, respectively. The node-based path enumerating step is performed to enumerate all of the state values of the state vectors of the paths by adding 1 to the binary value corresponding to the state values of the state vector of the one of the paths according to a binary-addition tree algorithm. The evaluating step is performed to evaluate the state of the paths of the network according to the state values of the state vectors of the paths.

According to further another aspect of the present disclosure, a binary-addition tree algorithm-based network assessment system is configured to evaluate a state of a plurality of paths of a network, the paths include a node set and an arc set connected to the node set. The binary-addition tree algorithm-based network assessment system includes a memory and a processing unit. The memory accesses the network and a binary-addition tree algorithm, wherein the network includes the paths. The processing unit is electrically connected to the memory. The processing unit receives the network and the binary-addition tree algorithm and is configured to implement a binary-addition tree algorithm-based network assessment method. The binary-addition tree algorithm-based network assessment method includes a parameter setting step, a path enumerating step and an evaluating step. The parameter setting step is performed to set a plurality of state values of a state vector of one of the paths to 0, wherein the state vector of the one of the paths is represented by a binary value, and the state values of the state vector of the one of the paths are corresponding to one of the node set and the arc set. The path enumerating step is performed to enumerate all of the state values of the state vectors of the paths by adding 1 to the binary value corresponding to the state values of the state vector of the one of the paths according to the binary-addition tree algorithm. The evaluating step is performed to evaluate the state of the paths of the network according to the state values of the state vectors of the paths.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a binary-addition tree algorithm-based network assessment method according to a first embodiment of the present disclosure.

FIG. 2 shows a flow chart of a binary-addition tree algorithm-based network assessment method according to a second embodiment of the present disclosure.

FIG. 3 shows a schematic view of a network of the binary-addition tree algorithm-based network assessment method of FIG. 2.

FIG. 4 shows a flow chart of a binary-addition tree algorithm-based network assessment method according to a third embodiment of the present disclosure.

FIG. 5 shows a flow chart of a binary-addition tree algorithm-based network assessment method according to a fourth embodiment of the present disclosure.

FIG. 6 shows a block diagram of a binary-addition tree algorithm-based network assessment system according to a fifth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

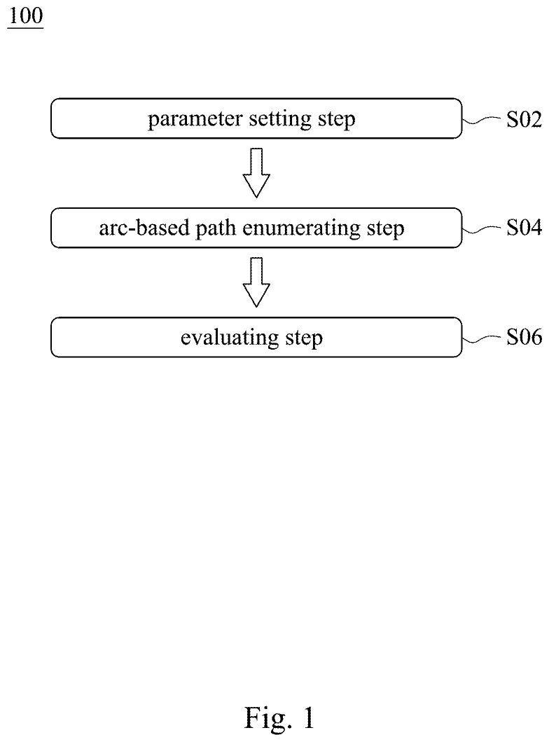

Please refer to FIG. 1. FIG. 1 shows a flow chart of a binary-addition tree algorithm-based network assessment method 100. The binary-addition tree algorithm-based network assessment method 100 is configured to evaluate a state of a plurality of paths of a network. The paths include a plurality of nodes and a plurality of arcs which are connected to the nodes. The binary-addition tree algorithm-based network assessment method 100 includes a parameter setting step S02, an arc-based path enumerating step S04 and an evaluating step S06. The parameter setting step S02 is performed to set a plurality of state values of a state vector of one of the paths to 0. The state vector of the one of the paths is represented by a binary value, and the state values of the state vector of the one of the paths are corresponding to the arcs, respectively. Moreover, the arc-based path enumerating step S04 is performed to enumerate all of the state values of the state vectors of the paths by adding 1 to the binary value corresponding to the state values of the state vector of the one of the paths according to a binary-addition tree algorithm. The evaluating step S06 is performed to evaluate the state of the paths of the network according to the state values of the state vectors of the paths. Thus, the binary-addition tree algorithm-based network assessment method 100 of the present disclosure can comprehensively enumerate all the possible states of the arc-based paths by a method of exhaustion of the binary-addition tree algorithm to evaluate the state of the paths of the network, thereby simplifying program complexity, saving memory space and increasing efficiency and parallel processing. Each of the steps of the binary-addition tree algorithm-based network assessment method 100 is described in more detail below.

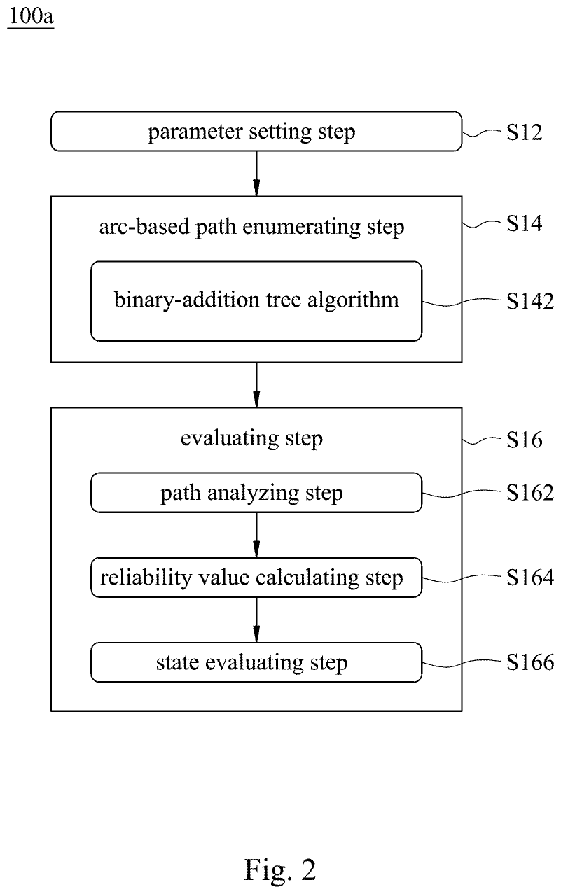

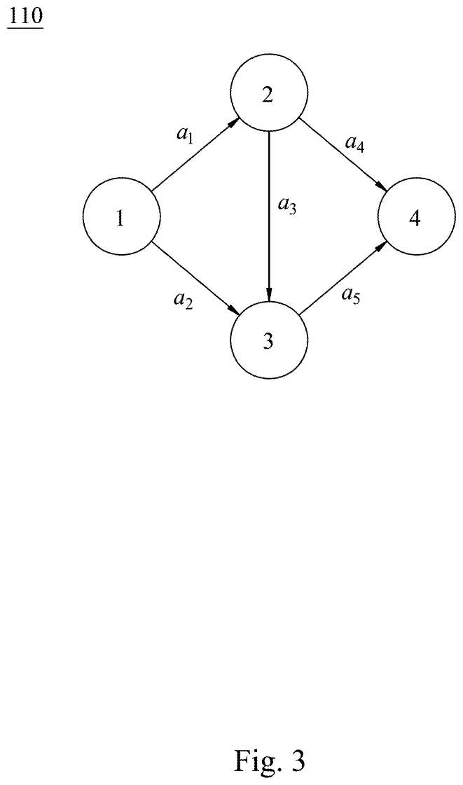

Please refer to FIG. 2 and FIG. 3. FIG. 2 shows a flow chart of a binary-addition tree algorithm-based network assessment method 100a according to a second embodiment of the present disclosure. FIG. 3 shows a schematic view of a network 110 of the binary-addition tree algorithm-based network assessment method 100a of FIG. 2. The binary-addition tree algorithm-based network assessment method 100a is configured to evaluate a state of a plurality of paths of a network 110. The paths include a plurality of nodes 1, 2, 3, 4 and a plurality of arcs a₁, a₂, a₃, a₄, a₅ which are connected to the nodes 1, 2, 3, 4. The nodes 1, 2, 3, 4 include a source node 1, connecting nodes 2, 3 and a sink node 4. The paths are formed between the source node 1 and the sink node 4. Moreover, the state of the paths can represent the resilience of the disruptive events, but the present disclosure is not limited thereto. The binary-addition tree algorithm-based network assessment method 100a includes a parameter setting step S12, an arc-based path enumerating step S14 and an evaluating step S16.

The parameter setting step S12 is performed to set a plurality of state values of a state vector Xᵢ of one of the paths to 0. The state vector Xᵢ of the one of the paths is represented by a binary value Bᵢ, and the state values of the state vector Xᵢ of the one of the paths are corresponding to the arcs aⱼ (such as the arcs a₁, a₂, a₃, a₄, a₅), respectively. In detail, a number of the paths is equal to 2^{m}, and m is represented as a number of the state values. i represents a vector sequence parameter of the state vector Xᵢ of the paths, and j represents a value sequence parameter of the state values. In FIG. 3, the arc a₁ represents a directed arc e_{1,2} pointing from the node 1 to the node 2, the arc a₂ represents a directed arc e_{1,3} pointing from the node 1 to the node 3, the arc a₃ represents a directed arc e_{2,3} pointing from the node 2 to the node 3, the arc a₄ represents a directed arc e_{2,4} pointing from the node 2 to the node 4, and the arc a₅ represents a directed arc e_{3,4} pointing from the node 3 to the node 4. The number of the paths of arc-based is equal to 2⁵=32, m is equal to 5, and i is equal to a positive integer between 1 to 32, as listed in Table 1. The parameter setting step S12 includes a first setting step and a second setting step. The first setting step is performed to set SUM and k to 0 and 1, respectively, wherein SUM represents as a connected state number of the state values (i.e., X(aⱼ), j=1−m) of the state vector Xᵢ of one of the paths, and k represents as a group parameter of the state vectors Xᵢ of the paths and k is a positive integer. The connected state number represents a number of the X(aⱼ)=1. The second setting step is performed to set a kth state vector (i.e., state vector Xₖ) of the state vectors Xᵢ of the paths to the state values, and the state values are all set to 0, in other words, k is 1, Xₖ=X₁=(0,0,0,0,0). Moreover, when one of the state values is equal to 0, one of the arcs (i.e., one of the arcs a₁, a₂, a₃, a₄, a₅) corresponding to the one of the state values is in a disconnected state, otherwise, when one of the state values is equal to 1, the one of the arcs corresponding to the one of the state values is in a connected state.

TABLE 1

| i | Bᵢ | Xᵢ | Connected |
|---|---|---|---|
| 1 | 00000 | (0, 0, 0, 0, 0) | N |
| 2 | 00001 | (0, 0, 0, 0, 1) | N |
| 3 | 00010 | (0, 0, 0, 1, 0) | N |
| 4 | 00011 | (0, 0, 0, 1, 1) | N |
| 5 | 00100 | (0, 0, 1, 0, 0) | N |
| 6 | 00101 | (0, 0, 1, 0, 1) | N |
| 7 | 00110 | (0, 0, 1, 1, 0) | N |
| 8 | 00111 | (0, 0, 1, 1, 1) | N |
| 9 | 01000 | (0, 1, 0, 0, 0) | N |
| 10 | 01001 | (0, 1, 0, 0, 1) | Y |
| 11 | 01010 | (0, 1, 0, 1, 0) | N |
| 12 | 01011 | (0, 1, 0, 1, 1) | Y |
| 13 | 01100 | (0, 1, 1, 0, 0) | N |
| 14 | 01101 | (0, 1, 1, 0, 1) | Y |
| 15 | 01110 | (0, 1, 1, 1, 0) | N |
| 16 | 01111 | (0, 1, 1, 1, 1) | Y |
| 17 | 10000 | (1, 0, 0, 0, 0) | N |
| 18 | 10001 | (1, 0, 0, 0, 1) | N |
| 19 | 10010 | (1, 0, 0, 1, 0) | Y |
| 20 | 10011 | (1, 0, 0, 1, 1) | Y |
| 21 | 10100 | (1, 0, 1, 0, 0) | N |
| 22 | 10101 | (1, 0, 1, 0, 1) | Y |
| 23 | 10110 | (1, 0, 1, 1, 0) | Y |
| 24 | 10111 | (1, 0, 1, 1, 1) | Y |
| 25 | 11000 | (1, 1, 0, 0, 0) | N |
| 26 | 11001 | (1, 1, 0, 0, 1) | Y |
| 27 | 11010 | (1, 1, 0, 1, 0) | Y |
| 28 | 11011 | (1, 1, 0, 1, 1) | Y |
| 29 | 11100 | (1, 1, 1, 0, 0) | N |
| 30 | 11101 | (1, 1, 1, 0, 1) | Y |
| 31 | 11110 | (1, 1, 1, 1, 0) | Y |
| 32 | 11111 | (1, 1, 1, 1, 1) | Y |

The arc-based path enumerating step S14 is performed to enumerate all of the state values of the state vectors Xᵢ of the paths based on the arcs (a₁, a₂, a₃, a₄, a₅) by adding 1 to the binary value Bᵢ corresponding to the state values of the state vector Xᵢ of the one of the paths according to a binary-addition tree algorithm. In detail, the binary-addition tree algorithm S142 includes a first searching step, a second searching step, a third searching step and a fourth searching step. The first searching step is performed to set j to m, wherein j is represented as a value sequence parameter of the state values, and m is represented as a number of the state values. The second searching step is performed to verify whether a jth state value of the state values is 0. In response to determining that the jth state value is 0, the jth state value is set to 1, k is set to k+1, the kth state vector (Xₖ) is set to the state values, SUM is set to SUM+1, and the fourth searching step is performed, otherwise, in response to determining that the jth state value is not 0, the third searching step is performed. Furthermore, the third searching step is performed to set the jth state value to 0, and verify whether j is greater than 1. In response to determining that j is greater than 1, j is set to j−1, SUM is set to SUM−1, and the second searching step is performed, otherwise, in response to determining that j is smaller than or equal to 1, the fourth searching step is performed. The fourth searching step is performed to verify whether SUM is equal to m. In response to determining that SUM is equal to m, a 1th state vector to the kth state vector of the state vectors are the state vectors Xᵢ of all the paths, otherwise, in response to determining that SUM is not equal to m, the first searching step is performed again. The binary value Bᵢ is m bit. In Table 1, while performing the binary-addition tree algorithm S142 one time, the result is equivalent to the binary value Bᵢ corresponding to the state value of the previous state vector Xᵢ add 1 to obtain a binary value Bᵢ₊₁ corresponding to the state value of the present state vector Xᵢ₊₁. The binary values B₂, B₃, B₄, B₅ corresponding to the state vectors X₂, X₃, X₄, X₅ are satisfied by the formulas (1)-(4).

00000+1=00001 (1).

00001+1=00010 (2).

00010+1=00011 (3).

00011+1=00100 (4).

The binary value B₂ corresponding to the aforementioned state vector X₂ is “00001”, and the binary value B₂ is obtained by the binary value B₁ (i.e., “00000”) corresponding to the previous state vector X₁ adding 1. The binary value B₃ corresponding to the aforementioned state vector X₃ is “00010”, and the binary value B₃ is obtained by the binary value B₂ (i.e., “00001”) corresponding to the previous state vector X₂ adding 1. The binary value B₄ corresponding to the aforementioned state vector X₄ is “00011”, and the binary value B₄ is obtained by the binary value B₃ (i.e., “00010”) corresponding to the previous state vector X₃ adding 1. The binary value B₅ corresponding to the aforementioned state vector X₅ is “00100”, and the binary value B₅ is obtained by the binary value B₄ (i.e., “00011”) corresponding to the previous state vector X₄ adding 1. Other state vectors Xᵢ can be obtained by continuing in the same manner, and will not be described again.

The evaluating step S16 is performed to evaluate the state of the paths of the network 110 according to the state values of the state vectors Xᵢ of the paths. In detail, the evaluating step S16 includes a path analyzing step S162, a reliability value calculating step S164 and a state evaluating step S166. The path analyzing step S162 is performed to analyze at least one connected path of the paths according to the state values of the state vectors Xᵢ of the paths, wherein the at least one connected path is represented as a connection formed between the source node 1 and the sink node 4. The reliability value calculating step S164 is performed to calculate a reliability value of the at least one connected path of the paths according to the state values of the state vectors Xᵢ of the paths. Take Table 1 as an example, “Y” in the “Connected” represents as the connected path, “N” in the “Connected” represents as a disconnected path. The reliability value calculating step S164 calculates the reliability value of the connected path (i.e., X₁₀, X₁₂, X₁₄, X₁₆, X₁₉, X₂₀, X₂₂, X₂₃, X₂₄, X₂₆, X₂₇, X₂₈, X₃₀, X₃₁, X₃₂). Moreover, the state evaluating step S166 is performed to evaluate the state of the paths of the network 110 according to the reliability value of the at least one connected path of the paths. Thus, the binary-addition tree algorithm-based network assessment method 100a of the present disclosure can comprehensively enumerate all the possible states of the paths based on the arcs a₁, a₂, a₃, a₄, a₅ by a method of exhaustion of the binary-addition tree algorithm, thereby simplifying program complexity, saving memory space and increasing efficiency and parallel processing.

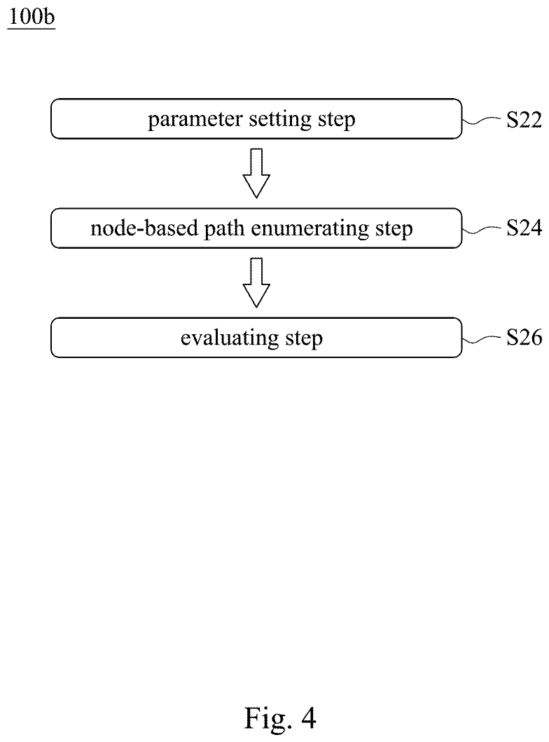

Please refer to FIG. 4. FIG. 4 shows a flow chart of a binary-addition tree algorithm-based network assessment method 100b according to a third embodiment of the present disclosure. As shown in FIG. 4, the binary-addition tree algorithm-based network assessment method 100b is configured to evaluate a state of a plurality of paths of a network. The paths include a plurality of nodes and a plurality of arcs connected to the nodes. The binary-addition tree algorithm-based network assessment method 100b includes a parameter setting step S22, a node-based path enumerating step S24 and an evaluating step S26. The parameter setting step S22 is performed to set a plurality of state values of a state vector of one of the paths to 0, wherein the state vector of the one of the paths is represented by a binary value, and the state values of the state vector of the one of the paths are corresponding to the nodes, respectively. The node-based path enumerating step S24 is performed to enumerate all of the state values of the state vectors of the paths by adding 1 to the binary value corresponding to the state values of the state vector of the one of the paths according to a binary-addition tree algorithm. The evaluating step S26 is performed to evaluate the state of the paths of the network according to the state values of the state vectors of the paths. Thus, the binary-addition tree algorithm-based network assessment method 100b of the present disclosure can comprehensively enumerate all the possible states of the node-based paths by a method of exhaustion of the binary-addition tree algorithm, thereby simplifying program complexity, saving memory space and increasing efficiency and parallel processing. Each of the steps of the binary-addition tree algorithm-based network assessment method 100b is described in more detail below.

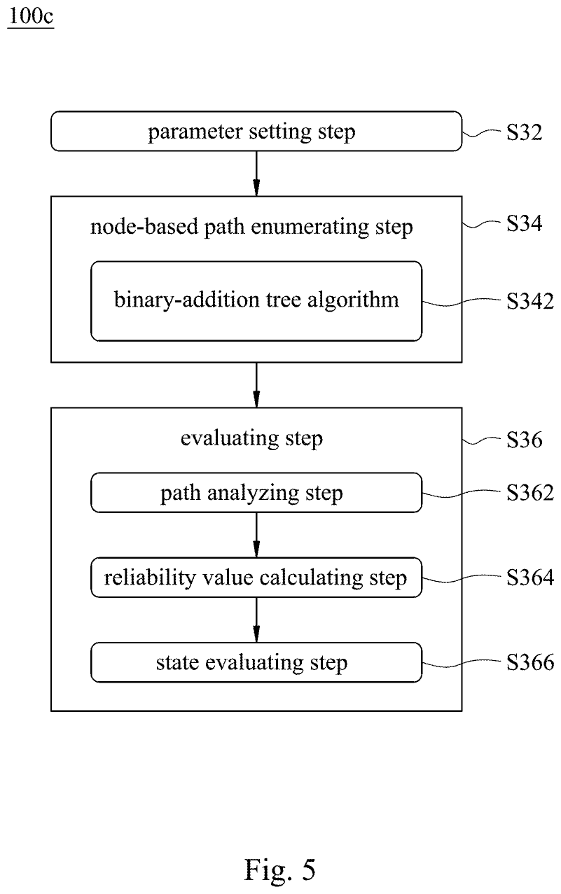

Please refer to FIG. 3 to FIG. 5. FIG. 5 shows a flow chart of a binary-addition tree algorithm-based network assessment method 100c according to a fourth embodiment of the present disclosure. As shown in FIG. 5, the binary-addition tree algorithm-based network assessment method 100c includes a parameter setting step S32, a node-based path enumerating step S34 and an evaluating step S36.

The parameter setting step S32 is performed to set a plurality of state values of a state vector Xᵢ of one of the paths to 0, wherein the state vector Xᵢ of the one of the paths is represented by a binary value Bᵢ, and the state values of the state vector Xᵢ of the one of the paths are corresponding to the nodes 1, 2, 3, 4, respectively. In detail, a number of the paths is equal to 2^{m}, and m is represented as a number of the state values, i represents a vector sequence parameter of the state vector Xᵢ of the paths, j represents a value sequence parameter of the state values. Take FIG. 3 as an example, the number of the paths of based on the nodes 1, 2, 3, 4 is equal to 2⁴=16, m is equal to 4, i is equal to a positive integer between 1 to 16, as listed in Table 2. The parameter setting step S32 includes a first setting step and a second setting step. The first setting step is performed to set SUM and k to 0 and 1, respectively, wherein SUM represents as a connected state number of the state values (i.e., X(j), j=1−m) of the state vector Xᵢ of the paths, and k represents as a group parameter of the state vectors Xᵢ of the paths. The connected state number represents a number of X(j)=1. The second setting step is performed to set a kth state vector (i.e., state vector Xₖ) of the state vectors Xᵢ of the paths to the state values, and the state values are all set to 0, in other words, k is 1, Xₖ=X₁=(0,0,0,0). Moreover, when one of the state values is equal to 0, one of the nodes (i.e., one of the nodes 1, 2, 3, 4) corresponding to the one of the state values is in a disconnected state, otherwise, when one of the state values is equal to 1, the one of the nodes corresponding to the one of the state values is in a connected state.

TABLE 2

| i | Bᵢ | Xᵢ | Connected |
|---|---|---|---|
| 1 | 0000 | (0, 0, 0, 0) | N |
| 2 | 0001 | (0, 0, 0, 1) | N |
| 3 | 0010 | (0, 0, 1, 0) | N |
| 4 | 0011 | (0, 0, 1, 1) | N |
| 5 | 0100 | (0, 1, 0, 0) | N |
| 6 | 0101 | (0, 1, 0, 1) | N |
| 7 | 0110 | (0, 1, 1, 0) | N |
| 8 | 0111 | (0, 1, 1, 1) | N |
| 9 | 1000 | (1, 0, 0, 0) | N |
| 10 | 1001 | (1, 0, 0, 1) | N |
| 11 | 1010 | (1, 0, 1, 0) | N |
| 12 | 1011 | (1, 0, 1, 1) | Y |
| 13 | 1100 | (1, 1, 0, 0) | N |
| 14 | 1101 | (1, 1, 0, 1) | Y |
| 15 | 1110 | (1, 1, 1, 0) | N |
| 16 | 1111 | (1, 1, 1, 1) | Y |

The node-based path enumerating step S34 is performed to enumerate all of the state values of the state vectors Xᵢ of the paths based on the nodes 1, 2, 3, 4 by adding 1 to the binary value B₁ corresponding to the state values of the state vectors Xᵢ of the one of the paths according to a binary-addition tree algorithm S342. The binary-addition tree algorithm S342 is the same as the binary-addition tree algorithm S142 of FIG. 2, and will not be described again.

The evaluating step S36 is performed to evaluate the state of the paths of the network 110 according to the state values of the state vectors Xᵢ of the paths based on the nodes 1, 2, 3, 4. In detail, the evaluating step S36 includes a path analyzing step S362, a reliability value calculating step S364 and a state evaluating step S366. The path analyzing step S362 is performed to analyze at least one connected path of the paths according to the state values of the state vectors of the paths, wherein the at least one connected path is represented as a connection formed between the source node 1 and the sink node 4. The reliability value calculating step S364 is performed to calculate a reliability value of the at least one connected path of the paths according to the state values of the state vector Xᵢ of the path. Take an example in Table 2, the reliability value calculating step S364 calculates the reliability value of the connected paths (i.e., X₁₂, X₁₄, X₁₆). Moreover, the state evaluating step S366 is performed to evaluate the state of the paths of the network 110 according to the reliability value of the at least one connected path of the paths. Thus, the binary-addition tree algorithm-based network assessment method 100c of the present disclosure can comprehensively enumerate all the possible states of the path based on the nodes 1, 2, 3, 4 by the binary-addition tree algorithm, thereby simplifying program complexity, saving memory space and increasing efficiency and parallel processing.

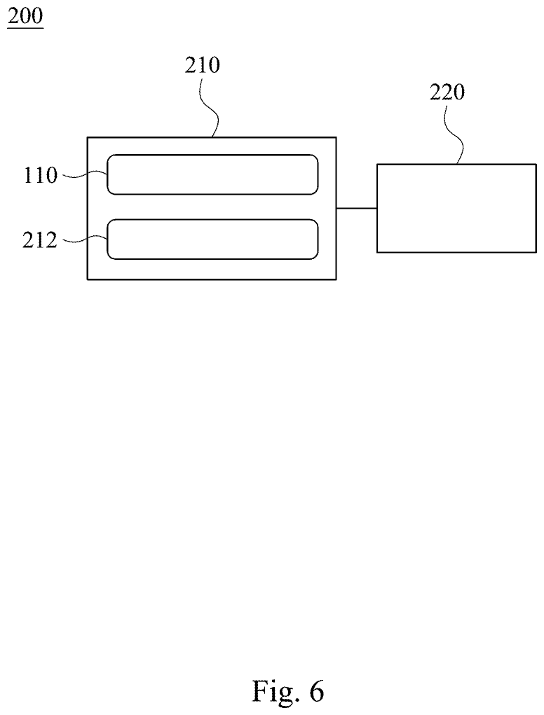

Please refer to FIG. 6. FIG. 6 shows a block diagram of a binary-addition tree algorithm-based network assessment system 200 according to a fifth embodiment of the present disclosure. The block diagram of a binary-addition tree algorithm-based network assessment system 200 is configured to evaluate a state of a plurality of paths of a network 110. The binary-addition tree algorithm-based network assessment system 200 includes a memory 210 and a processing unit 220.

The memory 210 accesses a network 110 and a binary-addition tree algorithm 212. The network 110 includes a plurality of paths, and the paths include a node set and an arc set connected to the node set. The node set includes the nodes 1, 2, 3, 4, and the arc set includes the arcs a₁, a₂, a₃, a₄, a₅ connected to the nodes 1, 2, 3, 4. The nodes 1, 2, 3, 4 include a source node 1, connecting nodes 2, 3 and a sink node 4. The paths are formed between the source node 1 and the sink node 4, a number of the paths is equal to 2^{m}, and m is represented as a number of the state values. Moreover, the binary-addition algorithm 212 is the same as the binary-addition tree algorithm S142 of FIG. 2 and the binary-addition tree algorithm S342 of FIG. 5, and will not be described again.

The processing unit 220 is electrically connected to the memory 210. The processing unit 220 receives the network 110 and the binary-addition tree algorithm 212 and is configured to implement the binary-addition tree algorithm-based network assessment methods 100, 100a, 100b and 100c. The processing unit 220 can be a microprocessor, a central processing unit (CPU) or other electronic processor, but the present disclosure is not limited thereto. Thus, the binary-addition tree algorithm-based network assessment system 200 of the present disclosure can comprehensively enumerate all the possible states of the paths by an exhaustion method of the binary-addition tree algorithm, thereby simplifying program complexity, saving memory space and increasing efficiency and parallel processing.

In other embodiments of the present disclosure, all the state values of the state vectors of the paths can be set to 1, and enumerates all the state values of the state vectors of the paths by subtracting 1 to the binary value corresponding to the state values until the m bit binary values are all 0, but the present disclosure is not limited thereto.

According to the aforementioned embodiments and examples, the advantages of the present disclosure are described as follows.

1. Enumerating all the possible states of the path based on the arcs by the exhaustion method of the binary-addition tree algorithm, thereby simplifying program complexity, saving memory space and increasing efficiency and parallel processing.

2. Enumerating all the possible states of the path based on the nodes by the exhaustion method of the binary-addition tree algorithm, thereby simplifying program complexity, saving memory space and increasing efficiency and parallel processing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A binary-addition tree algorithm-based network assessment method, which is configured to evaluate a state of a plurality of paths of a network, the paths comprising a plurality of nodes and a plurality of arcs connected to the nodes, and the binary-addition tree algorithm-based network assessment method comprising:
performing a parameter setting step to set a plurality of state values of a state vector of one of the paths to 0, wherein the state vector of the one of the paths is represented by a binary value, and the state values of the state vector of the one of the paths are corresponding to the arcs, respectively;
performing an arc-based path enumerating step to enumerate all of the state values of the state vectors of the paths by adding 1 to the binary value corresponding to the state values of the state vector of the one of the paths according to a binary-addition tree algorithm; and
performing an evaluating step to evaluate the state of the paths of the network according to the state values of the state vectors of the paths.

2. The binary-addition tree algorithm-based network assessment method of claim 1, wherein the nodes comprise a source node and a sink node, the paths are formed between the source node and the sink node, a number of the paths is equal to 2^{m}, and m is represented as a number of the state values.

3. The binary-addition tree algorithm-based network assessment method of claim 2, wherein the evaluating step comprises:
performing a path analyzing step to analyze at least one connected path of the paths according to the state values of the state vectors of the paths, wherein the at least one connected path is represented as a connection formed between the source node and the sink node.

4. The binary-addition tree algorithm-based network assessment method of claim 3, wherein the evaluating step further comprises:
performing a reliability value calculating step to calculate a reliability value of the at least one connected path of the paths according to the state values of the state vectors of the paths; and
performing a state evaluating step to evaluate the state of the paths of the network according to the reliability value of the at least one connected path of the paths.

5. The binary-addition tree algorithm-based network assessment method of claim 1, wherein,
the parameter setting step comprises:
setting SUM and k to 0 and 1, respectively, wherein SUM represents as a connected state number of the state values of the state vector of one of the paths, and k represents as a group parameter of the state vectors of the paths; and
setting a kth state vector of the state vectors of the paths to the state values, wherein the state values are all set to 0; and
the binary-addition tree algorithm comprises:
performing a first searching step to set j to m, wherein j is represented as a value sequence parameter of the state values, and m is represented as a number of the state values;
performing a second searching step to verify whether a jth state value of the state values is 0;
in response to determining that the jth state value is 0, setting the jth state value to 1, setting k to k+1, setting the kth state vector to the state values, setting SUM to SUM+1, and performing a fourth searching step; and
in response to determining that the jth state value is not 0, performing a third searching step;
performing the third searching step to set the jth state value to 0, and verify whether j is greater than 1;
in response to determining that j is greater than 1, setting j to j−1, setting SUM to SUM−1, and performing the second searching step; and
in response to determining that j is smaller than or equal to 1, performing the fourth searching step; and
performing the fourth searching step to verify whether SUM is equal to m;
in response to determining that SUM is equal to m, a 1th state vector to the kth state vector of the state vectors are the state vectors of all the paths; and
in response to determining that SUM is not equal to m, performing the first searching step.

6. The binary-addition tree algorithm-based network assessment method of claim 1, wherein,
in response to determining that one of the state values is equal to 0, one of the arcs corresponding to the one of the state values is in a disconnected state; and
in response to determining that the one of the state values is equal to 1, the one of the arcs corresponding to the one of the state values is in a connected state.

7. A binary-addition tree algorithm-based network assessment method, which is configured to evaluate a state of a plurality of paths of a network, the paths comprising a plurality of nodes and a plurality of arcs connected to the nodes, and the binary-addition tree algorithm-based network assessment method comprising:
performing a parameter setting step to set a plurality of state values of a state vector of one of the paths to 0, wherein the state vector of the one of the paths is represented by a binary value, and the state values of the state vector of the one of the paths are corresponding to the nodes, respectively;
performing a node-based path enumerating step to enumerate all of the state values of the state vectors of the paths by adding 1 to the binary value corresponding to the state values of the state vector of the one of the paths according to a binary-addition tree algorithm; and
performing an evaluating step to evaluate the state of the paths of the network according to the state values of the state vectors of the paths.

8. The binary-addition tree algorithm-based network assessment method of claim 7, wherein the nodes comprise a source node and a sink node, the paths are formed between the source node and the sink node, a number of the paths is equal to 2^{m}, and m is represented as a number of the state values.

9. The binary-addition tree algorithm-based network assessment method of claim 8, wherein the evaluating step comprises:
performing a path analyzing step to analyze at least one connected path of the paths according to the state values of the state vectors of the paths, wherein the at least one connected path is represented as a connection formed between the source node and the sink node.

10. The binary-addition tree algorithm-based network assessment method of claim 9, wherein the evaluating step further comprises:
performing a reliability value calculating step to calculate a reliability value of the at least one connected path of the paths according to the state values of the state vectors of the paths; and
performing a state evaluating step to evaluate the state of the paths of the network according to the reliability value of the at least one connected path of the paths.

11. The binary-addition tree algorithm-based network assessment method of claim 7, wherein,
the parameter setting step comprises:
setting SUM and k to 0 and 1, respectively, wherein SUM represents as a connected state number of the state values of the state vector of one of the paths, and k represents as a group parameter of the state vectors of the paths; and
setting a kth state vector of the state vectors of the paths to the state values, wherein the state values are all set to 0; and
the binary-addition tree algorithm comprises:
performing a first searching step to set j to m, wherein j is represented as a value sequence parameter of the state values, and m is represented as a number of the state values;
performing a second searching step to verify whether a jth state value of the state values is 0;
in response to determining that the jth state value is 0, setting the jth state value to 1, setting k to k+1, setting the kth state vector to the state values, setting SUM to SUM+1, and performing a fourth searching step; and
in response to determining that the jth state value is not 0, performing a third searching step;
performing the third searching step to set the jth state value to 0, and verify whether j is greater than 1;
in response to determining that j is greater than 1, setting j to j−1, setting SUM to SUM−1, and performing the second searching step; and
in response to determining that j is smaller than or equal to 1, performing the fourth searching step; and
performing the fourth searching step to verify whether SUM is equal to m;
in response to determining that SUM is equal to m, a 1th state vector to the kth state vector of the state vectors are the state vectors of all the paths; and
in response to determining that SUM is not equal to m, performing the first searching step.

12. The binary-addition tree algorithm-based network assessment method of claim 7, wherein,
in response to determining that one of the state values is equal to 0, one of the nodes corresponding to the one of the state values is in a disconnected state; and
in response to determining that the one of the state values is equal to 1, the one of the nodes corresponding to the one of the state values is in a connected state.

13. A binary-addition tree algorithm-based network assessment system, which is configured to evaluate a state of a plurality of paths of a network, the paths comprising a node set and an arc set connected to the node set, and the binary-addition tree algorithm-based network assessment system comprising:
a memory accessing the network and a binary-addition tree algorithm, wherein the network comprises the paths; and
a processing unit electrically connected to the memory, wherein the processing unit receives the network and the binary-addition tree algorithm and is configured to implement a binary-addition tree algorithm-based network assessment method comprising:
performing a parameter setting step to set a plurality of state values of a state vector of one of the paths to 0, wherein the state vector of the one of the paths is represented by a binary value, and the state values of the state vector of the one of the paths are corresponding to one of the node set and the arc set;
performing a path enumerating step to enumerate all of the state values of the state vectors of the paths by adding 1 to the binary value corresponding to the state values of the state vector of the one of the paths according to the binary-addition tree algorithm; and
performing an evaluating step to evaluate the state of the paths of the network according to the state values of the state vectors of the paths.

14. The binary-addition tree algorithm-based network assessment system of claim 13, wherein the node set comprises a plurality of nodes, the arc set comprises a plurality of the arcs connected to the nodes, the nodes comprise a source node and a sink node, the paths are formed between the source node and the sink node, a number of the paths is equal to 2^{m}, and m is represented as a number of the state values.

15. The binary-addition tree algorithm-based network assessment system of claim 14, wherein the evaluating step comprises:
performing a path analyzing step to analyze at least one connected path of the paths according to the state values of the state vectors of the paths, wherein the at least one connected path is represented as a connection formed between the source node and the sink node.

16. The binary-addition tree algorithm-based network assessment system of claim 15, wherein the evaluating step further comprises:
performing a reliability value calculating step to calculate a reliability value of the at least one connected path of the paths according to the state values of the state vectors of the paths; and
performing a state evaluating step to evaluate the state of the paths of the network according to the reliability value of the at least one connected path of the paths.

17. The binary-addition tree algorithm-based network assessment system of claim 13, wherein,
the parameter setting step comprises:
setting SUM and k to 0 and 1, respectively, wherein SUM represents as a connected state number of the state values of the state vector of one of the paths, and k represents as a group parameter of the state vectors of the paths; and
setting a kth state vector of the state vectors of the paths to the state values, wherein the state values are all set to 0; and
the binary-addition tree algorithm comprises:
performing a first searching step to set j to m, wherein j is represented as a value sequence parameter of the state values, and m is represented as a number of the state values;
performing a second searching step to verify whether a jth state value of the state values is 0;
in response to determining that the jth state value is 0, setting the jth state value to 1, setting k to k+1, setting the kth state vector to the state values, setting SUM to SUM+1, and performing a fourth searching step; and
in response to determining that the jth state value is not 0, performing a third searching step;
performing the third searching step to set the jth state value to 0, and verify whether j is greater than 1;
in response to determining that j is greater than 1, setting j to j−1, setting SUM to SUM−1, and performing the second searching step; and
in response to determining that j is smaller than or equal to 1, performing the fourth searching step; and
performing the fourth searching step to verify whether SUM is equal to m;
in response to determining that SUM is equal to m, a 1th state vector to the kth state vector of the state vectors are the state vectors of all the paths; and
in response to determining that SUM is not equal to m, performing the first searching step.

18. The binary-addition tree algorithm-based network assessment system of claim 13, wherein,
in response to determining that the one of the node set and the arc set is the node set,
in response to determining that one of the state values is equal to 0, the one of the nodes corresponding to the one of the state values is in a disconnected state; and
in response to determining that the one of the state values is equal to 1, the one of the nodes corresponding to the one of the state values is in a connected state; and
in response to determining that the one of the node set and the arc set is the arc set,
in response to determining that one of the state values is equal to 0, the one of the arcs corresponding to the one of the state values is in the disconnected state; and
in response to determining that the one of the state values is equal to 1, the one of the arcs corresponding to the one of the state values is in the connected state.
